(19) United States
(12) Patent Application Publication
(10) Pub. No.: US 2017/0318813 A1
(43) Pub. Date: Nov. 9, 2017

(54) ANTIMICROBIAL AGENT FOR THE BIOCIDAL FINISH OF POLYMERS

(71) Applicant: Wenatex Forschung - Entwicklung - Produktion GmbH, Braunau am Inn - Ranshofen (AT)

(72) Inventor: Karl RAMETSTEINER, Linz (AT)

(73) Assignee: Wenatex Forschung - Entwicklung - Produktion GmbH, Braunau am Inn - Ranshofen (AT)

(21) Appl. No.: 15/524,018

(22) PCT Filed: Nov. 20, 2015
(86) PCT No.: PCT/AT2015/050296

§ 371 Date: May 3, 2017

(30) Foreign Application Priority Data
Nov. 20, 2014 (AT) A50844/2014

(51) Int. Cl. A01N 55/02; A01N 43/76; A01N 25/10; A01N 43/40; A01N 43/80; A01N 43/78

(52) U.S. Cl. CPC A01N 55/02; A01N 43/80; A01N 43/78; A01N 25/10; A01N 43/40; A01N 43/76

(57) ABSTRACT

An antimicrobial agent for the biocidal finish of polymers based on biocides is described, whose molecules have at least one nitrogen atom with a free electron pair. In order to achieve an extensive insolubility without loss of the biocidal effect, it is proposed that the biocide is coordinatively bound to a metal complex via the free electron pair of the nitrogen atom.

### 1. FIELD OF THE INVENTION

The invention relates to an antimicrobial agent for the biocidal finish of polymers based on biocides, whose molecules have at least one nitrogen atom with a free electron pair.

### 2. DESCRIPTION OF THE PRIOR ART

For the biocidal finish of polymers, in particular polyurethane foams and polymer fibres used in the textile industry based on polyethylene terephthalate (PET), polyacrylonitrile (PAN), polypropylene (PP) and the like, attempts are made on the one hand to intervene in the metabolism of the micro-organisms and on the other hand to remove the food basis from the micro-organisms. The most effective biocides for this have a relative molecular mass significantly below 1000, which generally assists the volatility, solubility and migration propensity of these active substances. In order to avoid environmental pollution by these biocides, it is known (EP 2 420 521 A1, EP 2 505 059 A1) to increase the molecular mass by polymerization of the active substances or binding to polymers and to strive for a covalent binding of the active substances to the polymer matrix. Thus, for example, a number of biocides with effective primary and secondary amines or with reactive hydroxyl groups in the molecule can be successfully bound in a polyurethane or epoxy resin matrix. However, the most effective biocides frequently only contain tertiary bound nitrogen, no (sufficiently reactive) hydroxyl groups or secondary amino groups which are so sluggish to react that they only react subsequently with the polyaddition partners so that polyaddition has priority over the covalent bond. Furthermore, the most effective base molecules in covalently bonded form frequently lose their exceptional effect because they must retain a certain mobility (solubility) for the development of this biological effect.

### SUMMARY OF THE INVENTION

It is therefore the object of the invention to provide an antimicrobial agent which despite a good solubility of its biocidal molecules in water largely eliminates any environmental pollution by the biocide molecules even in a long-term effect without needing to accept any restrictions with regard to the biocidal effect.

Starting from an antimicrobial agent of the type described initially, the invention solves the formulated object whereby the biocide is coordinatively bound to a metal complex via the free electron pair of the nitrogen atom.

It has surprisingly been shown that antimicrobial agents in which the biocide is coordinatively bound to a metal complex are usually not water-soluble but retain the antimicrobial effect of the biocide although the biocide molecules should be considered to be non-volatile. This is attributed to the coordination bond which allows a sufficient mobility of the biocide molecules permanently bound to the metal complex in order to ensure an interaction with the surface of the micro-organisms to be combated.

Imidazoles, benzimidazoles, oxazoles, isoxazoles, oxadiazoles, biguanides, thiazoles, isothiazoles, pyrimidines and pyridines have proved to be advantageous biocides in this context. In particular, phthalocyanines with copper, zinc, tin, iron or cobalt as central atom, porphyrines with magnesium, copper or iron as central atom or corroles with copper, zinc, iron, gold, silver, vanadium, molybdenum or cobalt as central atom come into consideration as metal complexes. As a result of the different coordination numbers 2, 4 and 6 of the central atoms, depending on the type of metallic central atoms of the metal complexes, several nitrogen-containing biocide molecules or biocide molecules can be multiply docked so that there are various binding possibilities with regard to the quantity and stability.

When using a phthalocyanine with copper as central atom, the possible planar arrangement of the ligands as a result of the coordination number 4 of the copper can advantageously be used to coordinatively bind larger biocide molecules with a sufficient mobility. Biguanides are particularly suitable for this purpose, wherein the cooper atom can be bound to respectively one nitrogen atom of two biguanide molecules but usually in order to use particularly stable relationships, only one biguanide molecule is coordinatively bound to the central copper atom. Advantageously suitable as biguanide are polyaminopropyl biguanide (relative molecular mass Mᵣ=800-10000) having the structural formula

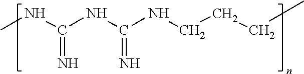

where n=5-50,
a polyhexamethylene biguanide (Mᵣ=800-10000) having the structural formula

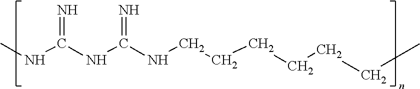

where n=5-50,
and a polyoxyalkylene biguanide (Mᵣ=1000-15000) having the structural formula

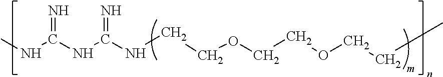

where m=2-10 and n=5-50.

Porphyrines such as chlorophylls with magnesium or copper as central atoms show a definite affinity to imidazoles, benzimidazoles and nitrogen sulphur compounds for steric reasons.

An imidazole having the structural formula

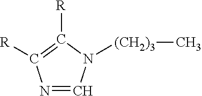

where: R=hydrogen, an alkyl or a halogen,
or a benzimidazole having the structural formula

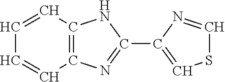 [SMILES: c1ccc2[nH]c(-c3cscn3)nc2c1]

can be given as examples in this context. The same applies to corroles, in particular cobalamine with cobalt as central atom.

Porphyrines with iron as central atom, e.g. hemins, can be coordinatively bound with a low-molecular biguanide, preferably a hexamethylene bis(p-chlorophenyl) biguanide having the structural formula

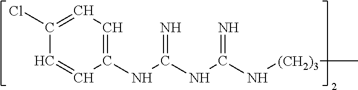

but also with oxygen-nitrogen heterocyclic compounds such as an isothiazole having the structural formula

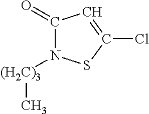

an isoxazole having the structural formula

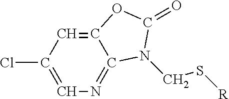

where R=hydrogen, an alkyl or a halogen,
or an oxadiazole having the structural formula.

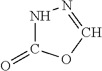

In this context, a biocide based on oxygen, nitrogen, sulphur, in particular a 2-mercaptopyridine N-oxide having the structural formula

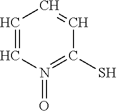

can also advantageously be used.

The following examples are intended to explain the invention, and show the biocidal effect and its stability with respect to migration and elution but do not restrict the inventive subject matter.

### EXAMPLE 1

Phthalocyanine with copper as central atom (CuPhthC) occurs in a total of 11 stereo-specific configurations of which the α, β and ε variants are used technically. Purely visually they are distinguished by different blue shades:
α red-tinged blue, thermally not very stable
β green-tinged blue, thermally highly stable
ε strongly red-tinged blue, chemically unstable, less reactive than α and β so that only the ε variant is used according to the invention.

57.6 g (0.1 mol) of CuPhthC is suspended in 200 ml of dimethyl formamide (DMF) and mixed under heat (60° C.) with 1300 g (0.1 mol) of polyhexamethylene biguanide (polyhexanide), relative mass Mᵣ=1298, dissolved in 1800 ml of H₂O and agitated for 2 hours. The red-tinged component very rapidly loses its colour, the suspension becomes significantly more viscous.

After filtration and drying the product obtained, 1216 g of the coordination compound 1 mol CuPhthC+1 mol polyhexanide was obtained as an azure blue colour.

### EXAMPLE 2

73 g (0.1 mol) of a copper-containing chlorophylline (CuChloroph) available commercially as E141—natural green (food colouring) was partially dissolved, partially suspended in 250 ml of water and mixed with 20.3 g (0.1 mol) of 2-(4-thiazolyl)benzimidazole (“thiobendazole”) and the green suspension was agitated for 30 minutes at room temperature. The shade was significantly more intense and yellow-tinged. After isolation, 85.4 g of the coordination component 1 mol CuChloroph 1 mol thiobendazole was obtained as a greenish yellow colour.

### EXAMPLE 3

67 g (1 mol) of pyrrol was reflux-boiled with 92 g (1 mol) of 4-methylbenzaldehyde in 400 ml of methanol+20 ml conc. HCl in a nitrogen atmosphere for 1 hour, whereby a dark blue solution of tetratolyl porphyrine was spontaneously obtained. After adding 136 g (1 mol) of zinc chloride, a suspension of the porphyrine zinc complex was obtained. 282 g of 4,5-dichloro-2-octylisothiazolone (DCOIT) was then added and after a 1 hour agitating phase, the deep-blue coordination compound formed was extracted. After drying, 310 g of tetratolyl porphyrine/Zn/DCOIT coordination compound was obtained.

### EXAMPLE 4

6.52 g (0.01 mol) of hemin was dissolved in 250 ml of distilled H2O and mixed with 1.5 g (0.01 mol) of 2-pyridinthiol-1-oxide (pyrithione), sodium salt, whereupon a reddish brown precipitate of the predicted coordination compound 1 mol hemin+1 mol pyrithione was obtained. After the usual isolation, 7.4 g of the desired product was obtained.

The following examples are intended to show the biocidal effect when incorporated in a polyurethane foam.

### EXAMPLE 5

95 g of a trifunctional polypropylene glycol (OH number: 46), 3.4 g of H₂O, 2.0 g of silicon stabilizer based on a polysiloxane polyethylene glycol copolymer and 1.5 g of 1,4-diazabicyclo[2.2.2]octane (DABCO) as foam catalyst dissolved in 3 g of tripropylene glycol are intensively mixed with 65 g of diphenylmethane diisocyanate (MDI) having an NCO content of 29.5% corresponding to an NCO index of 103% and foamed within about 60 seconds to an elastic foam having a weight per unit volume RG=45 kg/m³. A part of this foam is used as a proof sample (zero sample).

### EXAMPLE 6

Similar to Example 5 but with a 5% addition (0.85 g) of polyhexanide, Mᵣ=1300) relative to the total weight of 170 g. The foam obtained had a weight per unit volume RG=46 kg/m³.

### EXAMPLE 7

Similar to Example 5 but with a 0.3%=0.50 g addition of thiabendazole relative to the total weight. The foam obtained had a weight per unit volume RG=45 kg/m³.

### EXAMPLE 8

As Example 5 but with an addition of 0.45% of a CuPhtC/polyhexanide complex (corresponding to 0.5% polyhexanide from Example 1.

### EXAMPLE 9

Similar to Example 5 but with an addition of 1.8% of a coordination complex from Example 2 (corresponding to 0.4% thiabendazole).

### EXAMPLE 10

105 g of the polyol mixture according to Example 5 is mixed intensively with 0.05 g of ε-copper phthalocyanine and 0.6 g of polyhexanide hydrogen chloride and after a waiting time of 15 minutes mixed with 65 g of methylene diphenyl diisocyanate (MDI) similar to Example 5 and foamed. The foam obtained had a weight per unit volume RG=46 kg/m³.

### EXAMPLE 11

95 g of a polyol mixture according to Example 5 is mixed homogeneously with 5.03 g of a finely dispersed mixture of 0.03 g of Cu-phthalocyanine in 5.0 g of the trifunctional base polypropylene glycol (OH number: 46) and 5.3 g of a finely dispersed mixture of 0.3 g of zinc pyrithione in 5.0 g of the same polypropylene glycol and foamed with 62.0 g of toluene diisocyanate in a known manner. A fine-pored open-cell foam having a weight per unit volume of 42 kg/m³ having biocidal properties according to Example 10 is obtained, where the biocidal properties were completely retained even after thirty washing cycles with water at 30° C. In a similar comparative foaming without Cu-phthalocyanine, the biocidal effect diminished to zero after just 6 washing cycles.

### Test of the Biocidal Effect

Samples were prepared from the foams according to Examples 5 to 10 under otherwise the same conditions and the antimicrobial activity was determined according to the Japanese industrial standard JIS Z 2801:2000 by determining the reduction factor IR for Escherichia coli (gram positive) and Staphylococcus aureus (gram negative) after a period of a week. The results are summarized in the following table. In this case, the values of the original sample are compared with those of the samples after washing three times in water at a temperature of 60° C. (not eluted/eluted).

| | |
|---|---|
| IR | IR |
| Escherichia coli | Staphylococcus aureus |

| Sample No. | Not eluted | Eluted | Not eluted | Eluted |
|---|---|---|---|---|
| 5 | 0.3 | −0.2 | 0.2 | 0.1 |
| 6 | 3.8 | 2.2 | 3.6 | 1.8 |
| 7 | 3.2 | 2.3 | 2.9 | 1.9 |
| 8 | 4.4 | 4.3 | 4.7 | 4.5 |
| 9 | 4.0 | 3.4 | 3.9 | 3.2 |
| 10 | 4.8 | 4.8 | 5.0 | 4.8 |

The low biocidal effect of the zero sample (No. 5) is attributed to the content of the tert. amine used as catalyst before elution.

A comparison of the reduction factor IR of Samples No. 8 to 10 according to the invention with the proof samples according to the prior art shows on the one hand the exceptional biocidal effect and on the other hand the good stability and insolubility of the coordination compounds which must be partly attributable to the chemical incorporation in the polyurethane matrix.

The examples were carried out with PUR soft foam but are naturally not restricted to cellular bodies nor to polyurethane. Comparative results were obtained with epoxy formulations for metal coatings.

When used in thermoplastics, in situ synthesis (according to Example 10) naturally cannot be used because of the lack of a temporary solvent. In this case, isolated coordination compounds (according to Examples 1 to 4) can be used, in which case the thermal stability (processing temperature usually >150-250° C.) should be checked in advance. Compared to this, the processing temperature for the aforementioned polyaddition plastics is a moderate 25-80° C.

1. Antimicrobial agent for the biocidal finish of polymers based on biocides, whose molecules have at least one nitrogen atom with a free electron pair, wherein the biocide is coordinatively bound to a metal complex via the free electron pair of the nitrogen atom.

2. The antimicrobial agent according to claim 1, wherein the biocide is an imidazole, benimidazole, oxazole, isoxazole, ozadiazole, biguanide, triazole, isothiazole, pyrimidine or a pyridine.

3. The antimicrobial agent according to claim 1, wherein the metal complex is a phthalocyanine with copper, zinc, tin, iron or cobalt as central atom, porphyrine with magnesium, copper or iron as central atom or a corrole with copper, zinc, iron, gold, silver, vanadium, molybdenum or cobalt as central atom.

4. The antimicrobial agent according to claim 2, wherein a phthalocyanine with copper as central atom is coordinatively bound with a polyaminopropyl biguanide, a polyhexamethylene biguanide or a polyoxyalkylene biguanide.

5. The antimicrobial agent according to claim 2, wherein a porphyrine with magnesium or copper as central atom is coordinatively bound with an imidazole or a benzimidazole.

6. The antimicrobial agent according to claim 2, wherein a porphryine with iron as central atom is coordinatively bound with a hexamethylene bis(p-chlorophenyl) biguanide, an oxazole, isoxazole or oxadiazole or a 2-mercaptopyridine nitrogen oxide.

7. Workpiece made of a polymer, in particular of a foam, wherein the workpiece is finished with an antimicrobial agent according to claim 1.
